(19) United States
(12) Patent Application Publication
(10) Pub. No.: US 2020/0144597 A1
(43) Pub. Date: May 7, 2020

(54) ADVANCED NEGATIVE ELECTRODE ARCHITECTURE FOR HIGH POWER APPLICATIONS

(71) Applicants: SINODE SYSTEMS, INC., Chicago, IL (US); NISSAN CHEMICAL CORPORATION, Tokyo (JP)

(72) Inventors: Seonbaek HA, Chicago, IL (US); Cary M. HAYNER, Chicago, IL (US); Joshua J. LAU, Chicago, IL (US); Aaron YOST, Evanston, IL (US); Jack CAVANAUGH, Chicago, IL (US); Francis WANG, Chicago, IL (US); Takahiro KASEYAMA, Funabashi-shi (JP); Tatsuya HATANAKA, Funabashi-shi (JP)

(21) Appl. No.: 16/178,877

(22) Filed: Nov. 2, 2018

(51) Int. Cl. H01M 4/133; H01M 4/04

(52) U.S. Cl. CPC H01M 4/133; H01M 2004/027; H01M 4/04

(57) ABSTRACT

The present application relates to composite particles for a negative electrode of an electrochemical cell, an anode including the composite particles, methods of forming the same. The composite particles each include: a capsule including crumpled sheets of a graphene material; a core encapsulated in the capsule, the core including an electrochemically active material; and carbon nanotubes (CNTs) disposed in capsule, the core, or both the capsule and the core.

### TECHNICAL FIELD

This invention relates to the art of electrochemical cells, and more particularly, to a new and improved electrochemical cell, and an anode composition for a negative electrode therefor. More particularly, the present invention is directed to an advanced anode composition for use in a secondary lithium ion electrochemical cell that promotes advanced performance for silicon (Si) based anodes, particularly at high rates of charge/discharge.

### BACKGROUND

The lithium-ion battery industry has demonstrated impressive double-digit growth since the year 2000 by becoming the energy storage technology of choice for portable power applications. The category is set to demonstrate even greater growth over the coming decade as countries around the world transition to electric transportation. With the increasing adoption of lithium-ion technology, there is an ever increasing need to extend today's energy and power densities, as applications migrate to longer run-times, wider power ranges and smaller form factors.

Lithium (Li) ion electrochemical cells typically have a relatively high energy density and are commonly used in a variety of applications which include consumer electronics, wearable computing devices, military mobile equipment, satellite communication, spacecraft devices and electric vehicles. Lithium ion cells are particularly popular for use in large-scale energy applications such as low-emission electric vehicles, renewable power plants and stationary electric grids. Additionally, lithium ion cells are at the forefront of new generation wireless and portable communication applications. One or more lithium ion cells may be used to configure a battery that serves as the power source for these applications. The explosion in the number of higher energy demanding applications and the limitations of existing lithium ion technology are accelerating research for higher energy density, higher power density, higher-rate charge-discharge capability, and longer cycle life lithium ion cells.

Silicon-based or silicon alloy anode materials have been included in most long-term lithium-ion technology adoption roadmaps as a practical means to achieve higher energy densities. Silicon is a desirable negative electrode active material for lithium ion electrochemical cell applications having a theoretical gravimetric capacity of about 4,200 mAh/g and volumetric capacity of about 9786 mAh/cm³ when fully lithiated. Market adoption of silicon-based anodes for use in lithium ion cells, however, has been challenged by rapid cycle life degradation, poor charge-discharge rate capability under high power demands, and subpar or deficient coulombic efficiency, all of which may result from extreme anode volume changes during charge and discharge (volume expansions of up to 400% have been noted). Cycle life degradation in silicon-based alloys is well understood, and can be broken down into two fundamental mechanisms: (1) electrical disconnection, and (2) unstable solid electrolyte interface (SEI). High rate capability and coulombic efficiency are also compromised by these mechanisms. Electrical disconnection occurs with significant volume fluctuations during charge and discharge due to large volume changes upon lithiation and delithiation.

These large volume changes may cause pulverization (stress-induced cracking and fracture) of the silicon particles and loss of electrical contact between these active silicon particles. The result is an electrochemical cell having low power capability and rapid capacity fade. The cracking and fracture introduced in mechanism (1) further worsens cell performance by subsequently promoting mechanism (2), an unstable SEI. Because cracking and fracture expose new Si surfaces to the electrolyte solvents, further SEI formation occurs, depositing lithiated compounds on the new Si surfaces. During charge/discharge cycling, the insulating SEI layer also grows thicker, further degrading the capacity and cycling stability of the Si anode, and compromising charge/discharge rate capability and coulombic efficiency.

Continuous and new growth of the SEI layer gradually deplete the available Li⁺ and, due to side reactions with the electrolyte solvent and salt(s), the amount of serviceable electrolyte is depleted as well, thereby deteriorating overall electrochemical cell performance. The use of silicon-based anodes in applications requiring high electrochemical cell charge/discharge rates, therefore, is severely limited resultant from the high ohmic and ionic contributions to polarization resulting from these mechanisms. Accordingly, there is a need for advanced electrode chemistries and material compositions for use in an electrochemical cell that simultaneously exhibit high energy density and high power performance capabilities particularly at high rates of charge/discharge. More specifically, there is also a need for advanced high energy silicon-based anode compositions which effectively minimize traditional failure mechanisms and enable high power performance.

### SUMMARY

According to various embodiments of the present disclosure, provided are composite particles for a negative electrode of an electrochemical cell, the composite particles each comprising: a capsule comprising crumpled sheets of a graphene material; a core encapsulated in the capsule, the core comprising an electrochemically active material; and carbon nanotubes (CNTs) disposed in the capsule, the core, or both the capsule and the core.

According to various embodiments of the present disclosure, provided is a method of making composite particles for a negative electrode of an electrochemical cell, the method comprising: mixing an active material, carbon nanotubes, and a graphene material to form a mixture; nebulizing the mixture to form droplets; evaporating the droplets to form a powder; and thermally reducing the particles to form the composite particles.

Other principal features and advantages of the invention will become apparent to those skilled in the art upon review of the following drawings, the detailed description, and the appended claims.

### BRIEF DESCRIPTION OF THE DRAWINGS

FIG. 1 is a perspective view of a crumpled ball-like composite particle.

FIG. 2A illustrates the method and apparatus 200 for forming crumpled ball-like composite particles, and FIG. 2B includes micrographs of products formed during stages of the method of FIG. 2A.

FIG. 3 illustrates an embodiment of a composite particle of an advanced anode material, according to various embodiments of the present disclosure.

FIGS. 4A through 4D illustrate cross sectional views of modified composite particles, according to various embodiments of the present disclosure.

FIGS. 5A, 5B, and 6-8 include block diagrams illustrating methods of forming the composite particles, according to various embodiments of the present disclosure.

FIG. 9A is a cross-sectional view of an anode, according to various embodiments of the present disclosure, FIG. 9B is a cross-sectional view of an anode including composite particles of FIG. 3, and FIG. 9C is a block diagram illustrating a method of forming an anode, according to various embodiments of the present disclosure.

FIG. 10 displays the Raman spectra for various examples of anode materials and compositions of the present application.

FIG. 11 includes a graph showing Electrochemical Impedance Spectroscopy (EIS) measurements for various examples of electrochemical half cells, according to various embodiments of the present disclosure.

FIG. 12 includes a graph of percent capacity retention vs. number of cycles for examples of electrochemical cells, according to various embodiments of the present disclosure.

FIG. 13 includes a graph of percent capacity retention vs. number of cycles for examples of electrochemical cells, according to various embodiments of the present disclosure.

### DETAILED DESCRIPTION OF THE PREFERRED EMBODIMENTS

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention. It will also be understood that the term “about” may refer to a minor measurement errors of, for example, 5 to 10%.

Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

Silicon and silicon alloys significantly increase cell capacity when incorporated within an electrode comprising graphite, graphene, or other carbon based active materials. Examples of electrodes comprising these carbon materials and silicon are provided in U.S. Pat. Nos. 8,551,650, 8,778,538, and 9,728,773 to Kung et al., and U.S. patent application publication numbers 2013/0004798 and 2013/0344392 to Huang et al., the contents all of which are fully incorporated herein by reference.

Carbon nanotubes (CNTs) have displayed great potential as anode materials for lithium ion electrochemical cells due to their unique structural, mechanical, electrical and thermal conductivity properties. CNTs, one type of the carbon-based anode materials, have high electrical and thermal conductivities and high aspect ratio which help them to form a network that is favorably electrically and thermally conductive. Outstanding mechanical properties of CNTs are derived from a combination of stiffness, strength, and tenacity. Tenacity is defined herein as strength-to-weight ratio in Pa m³/kg. Tenacity is a measure of the specific strength of CNTs, and is determined by the material strength of the CNT (force per unit area at failure) divided by the density of the CNT. CNTs are generally produced by an arc discharge process, chemical vapor deposition (CVD), laser ablation or the like. The CNTs used in this application may be obtained by any of these methods.

Types of CNTs are typically referred to as Single Walled Carbon Nanotubes (SWCNTs) consisting of a single cylindrically rolled graphene sheet, Double Walled Carbon Nanotubes (DWCNTs) consisting of two concentrically rolled graphene sheets, and Multi Walled Carbon Nanotubes (MWCNTs) consisting of a plurality of concentrically rolled graphite sheets. CNTs with particular combinations of N and M (structural parameters indicating how much the nanotube is twisted) can be highly electrically conducting, and hence can be said to be metallic. Their electrical conductivity has been shown to be a function of their chirality (degree of twist), as well as their diameter. CNTs can be either metallic or semi-conducting in their electrical behavior. Additionally, the carbon atoms of a single (graphene) sheet of graphite form a planar honeycomb lattice, in which each atom is connected via a strong chemical bond to three neighboring atoms. Because of these strong bonds, the basal-plane elastic modulus of graphite is one of the largest of any known material. For this reason, CNTs are high-strength fibers. SWCNTs are extremely stiff, and are very resistant to damage from physical forces. The strong in-plane graphitic C—C bonds make them exceptionally strong and stiff against axial strains. The almost zero in-plane thermal expansion but large inter-plane expansion of SWCNTs implies strong in-plane coupling and high flexibility against nonaxial strains. CNTs are a superior heat-conducting material as well. Ultra-small SWCNTs have been shown to exhibit superconductivity below 20° K.

CNT's have shown traction in high power applications by replacing high levels of carbon black and enabling more electroactive material within the electrode design, representing a very small, high aspect ratio conductive additive. Their high aspect ratio means that a lower loading (concentration) of CNTs is needed compared to other conductive additives to achieve the same electrical conductivity. This low loading preserves an electrode's toughness, contributing to performance properties of an electrode's matrix. The high aspect ratio (about 1000:1) of CNTs imparts electrical conductivity at lower material loadings compared to conventional additive materials such as carbon black, chopped carbon fiber, or carbon-based platelets. CNTs, an allotrope of graphite, have also shown much improved lithium capacity compared to graphite, due to their unique structures and properties. CNTs have been reported to display electrical conductivities as high as 106 S·m⁻¹ and 105 S·m⁻¹ for single-walled carbon nanotubes (SWCNTs) and multi-walled carbon nanotubes (MWCNTs), respectively, and high tensile strength up to 60 GPa.

The present application discloses, among other things, an advanced anode material composition for use in a negative electrode comprising an electrochemically active material containing two distinct constituents: (1) a particle structure consisting of crumpled composite particles comprising an electrically conductive carbon material capsule comprising either graphene sheets, GO sheets, at least partially reduced GO sheets, CNTs, or combinations thereof, encapsulating an electrochemically active material comprising either silicon, silicon alloys, CNTs or combinations thereof, (2) an electrically conductive electrode matrix comprising either a graphene-based material, a GO based material, a graphite based material, a carbon black based material, a CNT based material or combinations thereof, wherein the crumpled composite particles are supported within the matrix by a network of either scaffolded, wrapped or bonded electrically conductive carbon materials comprising either graphene sheets, GO sheets, CNTs or combinations thereof. Some embodiments may include a third constituent comprising a crosslinking polymer characterized by improving electrical conductivity of a negative electrode by its presence in the electrochemically active material encapsulated in the electrically conductive capsule, the electrically conductive capsule, the electrically conductive electrode matrix, the composite anode material, or combinations thereof.

Embodiments of the present application involve composite anode material particles comprising capsules of crumpled graphene or GO sheets that form a graphene or GO shell encapsulating an internal cargo of nanostructures composed of an electrochemically active material, for example, silicon. The encapsulating graphene or GO shell, the internal electrochemically active cargo, or both may include CNT enhancement. Examples of methods for forming dispersions comprising electrically conductive carbon and electrochemically active materials including the forming of their related composite particles are provided in the U.S. patents to Kung et al. and the U.S. patent applications to Huang et al. as disclosed previously, the contents of which are fully included herein by reference.

One embodiment of the present material comprises a capsule, the capsule comprising: a crumpled shell comprising a composite of at least one graphene or GO sheet having a crumpled morphology and CNTs; and electrochemically active silicon nanostructures encapsulated within the crumpled composite shell; wherein the average size of the capsules is less than 10 μm. The average size of the capsules may alternately be less than 1 μm. The average size of the capsules may range from 4-7 μm. The average size of the capsules may alternately range from 2-4 μm. The average size of the capsules may additionally range from 1-2 μm. As defined herein, “morphology” is defined as the structure and features of a surface. Specifically, “morphology” is the structure and features of the exterior surface of a composite particle of the electrochemically active material of the present application.

One embodiment of the present material comprises a composite capsule, the composite capsule comprising: a crumpled shell comprising at least one graphene or GO sheet having a crumpled morphology and at least one CNT; and a composite of silicon and CNT nanostructures encapsulated within the crumpled composite shell; wherein the average size of the capsules is less than 10 μm. The average size of the capsules may alternately be less than 1 μm. The average size of the capsules may range from 4-7 μm. The average size of the capsules may alternately range from 2-4 μm. The average size of the capsules may additionally range from 1-2 μm.

One embodiment of the present material comprises a layer of capsules, the capsules comprising: a crumpled graphene shell comprising graphene sheets having a crumpled morphology; and a composite of silicon and CNT nanostructures encapsulated within the crumpled composite shell; wherein the average size of the capsules is less than 10 μm. The average size of the capsules may alternately be less than 1 μm. The average size of the capsules may range from 4-7 μm. The average size of the capsules may alternately range from 2-4 μm. The average size of the capsules may additionally range from 1-2 μm.

One embodiment of a lithium ion battery having an anode comprising a CNT enhanced anode composition, wherein the anode composition comprises: (1) either a crumpled graphene shell, a crumpled GO shell, a CNT enhanced crumpled shell, or combinations thereof encapsulating either a silicon or silicon alloy active material or a CNT enhanced silicon or silicon alloy active material, and (2) an electrically conductive electrode matrix comprising either a graphene-based material, a GO based material, a graphite based material, a CNT based material or combinations thereof. Another embodiment comprises the elements of the above embodiment and a crosslinked polymer. Embodiments of batteries having this construction are characterized by a coulombic efficiency reaching 99% after about 50 cycles and a high loading level of about >2-3 mAh/cm² with current density of about 1 A/g.

According to various embodiments of the present disclosure, the anode composition may include one or more crosslinked polymers disposed in the electrically conductive carbon materials, the electrochemically active materials, and/or the negative electrode matrix material. The crosslinked polymer may be formed from crosslinkable polymers containing functional groups to facilitate conductivity of either the electrochemically active material encapsulated in the electrically conductive capsule, the electrically conductive carbon material shell, the electrically conductive electrode matrix, or combinations thereof. Examples of crosslinkable polymers that may be used include monofunctional monomers having a thermally crosslinkable group and one olefinic double bond per molecule, and multifunctional monomers having two or more olefinic double bonds per molecule. Examples of thermally crosslinkable groups include an epoxy group, an N-methylol amide group, an oxetanyl group, an oxazoline group, and combinations thereof. Embodiments of the present method comprise one or more water soluble crosslinked polymers.

One embodiment of the present material comprises a crosslinked polymer consisting of having a highly branched polymer or a pendant oxazoline groups according to the U.S. patent applications publication numbers 2016/0200850 to Hatanaka et al. and 2015/0228982 to Shibano et al., the contents of which are fully incorporated herein by reference. Examples of highly branched polymers include triarylamine-based highly branched polymers. Examples of pendant oxazoline group polymers are not particularly limited, so long as it is a polymer in which oxazoline groups are bonded directly or through a spacer group such as an alkylene group to repeating units making up the main chain. However, a polymer which is obtained by the radical polymerization of an oxazoline monomer having a polymerizable carbon-carbon double bond-containing group, and which has repeating units of the oxazoline ring to the polymer main chain or to spacer groups, is also acceptable. The pendant oxazoline polymer may be obtained by radical-polymerizing of at least two monomers: an oxazoline monomer having a polymerizable carbon-carbon double bond-containing group and a (meth)acrylic monomer having a hydrophilic functional group. The compound that gives rise to a crosslinking reaction with oxazoline groups is not particularly limited, provided it is a compound having two or more functional groups that react with oxazoline groups, such as carboxyl groups, hydroxyl groups, thiol groups, amino groups, sulfinic acid groups and epoxy groups.

One embodiment of the present material may include a crosslinking agent (e.g., an initiator) that is soluble in the above-described solvent. The crosslinking agent may be a compound that gives rise to a crosslinking reaction with the oxazoline groups on the oxazoline polymer, or may be a compound that is self-crosslinking. From the standpoint of further increasing the solvent resistance, a compound that gives rise to a crosslinking reaction with the oxazoline groups is preferred. The compound that gives rise to a crosslinking reaction with oxazoline groups is not particularly limited, provided it is a compound having two or more functional groups that react with oxazoline groups, such as carboxyl groups, hydroxyl groups, thiol groups, amino groups, sulfinic acid groups and epoxy groups. A compound having two or more carboxyl groups is preferred. Compounds which, under heating in the presence of an acid catalyst, form the above functional groups and give rise to crosslinking reactions, such as the sodium, potassium, lithium and ammonium salts of carboxylic acids, may also be used as crosslinking agents. Examples of compounds which give rise to crosslinking reactions with oxazoline groups include the metal salts of synthetic polymers such as polyacrylic acid and copolymers thereof or of natural polymers such as carboxymethylcellulose or alginic acid which give rise to crosslink reactivity in the presence of an acid catalyst, and ammonium salts of these same synthetic polymers and natural polymers which give rise to crosslink reactivity under heating. Sodium polyacrylate, lithium polyacrylate, ammonium polyacrylate, carboxymethylcellulose sodium, carboxymethylcellulose lithium and carboxymethylcellulose ammonium, which give rise to crosslink reactivity in the presence of an acid catalyst or under heating conditions, are especially preferred.

One embodiment of the present material comprises a dispersant comprising one of a polymer dispersant, a surfactant dispersant, and an inorganic dispersant. One embodiment of the present material comprises at least one of a dispersant comprising one of an electrostatically stabilizing dispersant, a steric stabilizing dispersant, a steric hindering dispersant, a surface-active dispersant such as to lower surface tension, interfacial tension, or improve wetting, and a non-surface active dispersant to de-aggregate, de-flocculate, or lower viscosity.

One embodiment of the present method of making crumpled conductive carbon material shells encapsulating a CNT enhanced Si-based composite cargo comprises the steps of: mixing silicon or a silicon alloy with CNT, mixing and then aerosol evaporating Si-CNT with graphene, and then thermally reducing the [Si-graphene]-CNT.

One embodiment of the present method of making CNT enhanced conductive carbon material shells encapsulating a Si-based composite cargo comprises the steps of: mixing and then aerosol evaporating silicon or a silicon alloy with graphene, mixing and then aerosol evaporating Si-graphene with CNT, and then thermally reducing the [Si-graphene]-CNT.

One embodiment of the present method of making CNT enhanced crumpled conductive carbon material shells encapsulating a CNT enhanced Si-based composite cargo comprises the steps of: mixing and then aerosol evaporating silicon or a silicon alloy with CNT, mixing and then aerosol evaporating [Si-CNT] with graphene, and then thermally reducing [Si-graphene]-CNT.

An alternative embodiment of the present method of making CNT enhanced crumpled conductive carbon material shells encapsulating a CNT enhanced Si-based composite cargo comprises the steps of: mixing and then aerosol evaporating silicon or a silicon alloy with CNT, mixing and then aerosol evaporating Si/CNT with CNT+graphene, and then thermally reducing [Si-graphene]-CNT.

As defined herein a “secondary” electrochemical cell is an electrochemical cell or battery that is rechargeable. “Capacity” is defined herein as the maximum amount of energy, in ampere-hours (Ah), that can be extracted from a battery under certain specified conditions; the amount of electric charge that can be delivered at a rated voltage. Capacity may also be defined by the equation: capacity=energy/voltage or current (A)×time (h). “Energy” is mathematically defined by the equation: energy=capacity (Ah)×voltage (V). “Specific capacity” is defined herein as the amount of electric charge that can be delivered for a specified amount of time per unit of mass or unit of volume of active electrode material. Specific capacity may be measured in gravimetric units, for example, (Ah)/g or volumetric units, for example, (Ah)/cc. Specific capacity is defined by the mathematical equation: specific capacity (Ah/Kg)=capacity (Ah)/mass (Kg). “Rate capability” is the ability of an electrochemical cell to receive or deliver an amount of capacity or energy within a specified time period. Alternately, “rate capability” is the maximum continuous or pulsed output current a battery can provide per unit of time. Thus, an increased rate of charge delivery occurs when a cell discharges an increased amount of current per unit of time in comparison to a similarly built cell, but of a different anode and/or cathode chemistry. “C-rate” is defined herein as a measure of the rate at which a battery is discharged relative to its maximum capacity. For example, a 1C rate means that the discharge current will discharge the entire battery in 1 hour. “Power” is defined as the time rate of energy transfer, measured in Watts (W). Power is the product of the voltage (V) across a battery or cell and the current (A) through the battery or cell. “C-Rate” is mathematically defined as C-Rate (inverse hours)=current (A)/capacity (Ah) or C-Rate (inverse hours)=1/discharge time (h). Power is defined by the mathematical equations: power (W)=energy (Wh)/time (h) or power (W)=current (A)×voltage (V). Coulombic efficiency is the efficiency at which charge is transferred within an electrochemical cell. Coulombic efficiency is the ratio of the output of charge by a battery to the input of charge.

A “composite anode material” is defined as a material that may be configured for use as an anode within an electrochemical cell, such as a lithium ion rechargeable battery. A “composite anode material” is also defined to include active material particles combined with particles of electrically conductive carbon materials, either as a single material of a specific carbon type, or combinations of more than one specific carbon type. The anode material may include composite anode material particles, a binder, and may optionally include a non-crosslinking and/or a crosslinking polymer. An “electrochemically active material” or “active material” is defined herein as a material that inserts and releases ions, such as ions in an electrolyte, to store and release an electrical potential.

An “active material” or “active material particle” is defined as a material or particle capable of repeating lithium intercalation and deintercalation. A “composite active material particle” is defined as particle having a first component comprising a conductive material and having a second component comprising an active material. A “capsule” is defined as a particle structure that encloses, envelops, or encapsulates a core material; a sack containing a core material. As used herein, the terms “capsule” and “shell” are synonymous and can be used interchangeably. An “internal cargo” is defined as a core material contained within or encapsulated by a capsule or shell; an innermost part inside of or encapsulated by a structure. The term “crumpled” is defined as a body or mass displaying a distribution of creases, ripples, folds, wrinkles, and ridges; to make or become curved. A “ball-like” particle is defined as a curved, a round or roundish body or mass; a spherical or ovoid body.

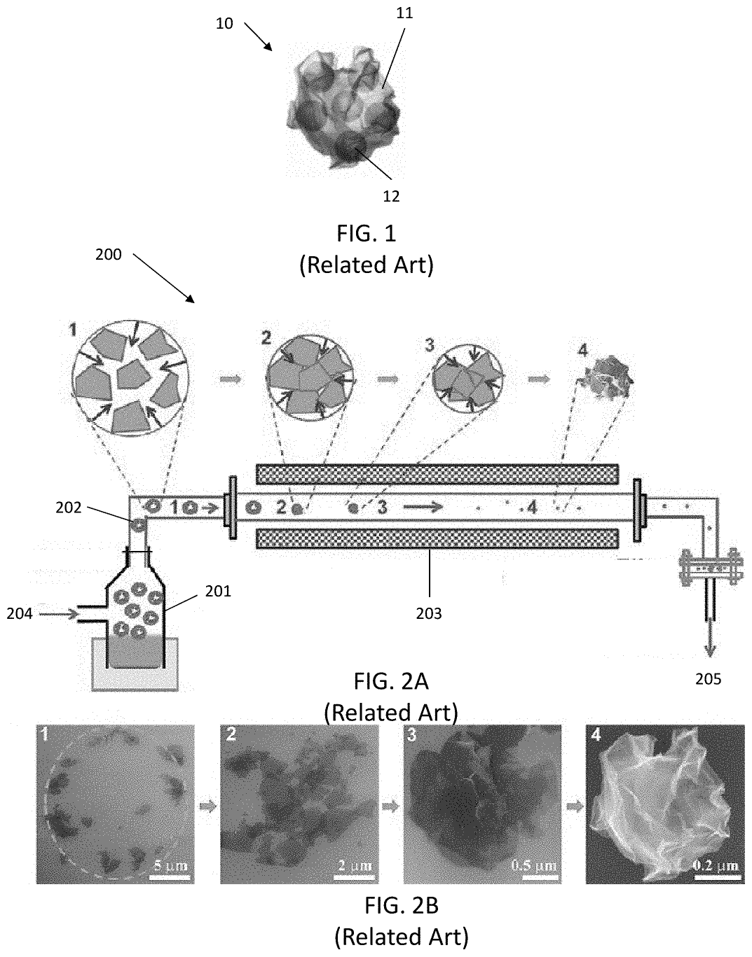

FIG. 1 is a perspective view of a conventional anode material particle 10 comprising a capsule comprising crumpled graphene sheets 11 and encapsulating a core (e.g., internal cargo) comprising nanostructures 12 of a second component. The carbon material capsules 101 are well suited for use as anode materials in lithium ion batteries for a number of reasons. First, carbon materials are highly electrically conductive and lithium transportable. Second, the voids inside a crumpled carbon material and the wrinkles on a crumpled carbon material shell allow the nanostructures 12 within to expand and contract freely without rupturing the crumpled shell. Third, the mechanically stable crumpled carbon material shell 101 can isolate the internal nanostructures 12, preventing them from contacting the electrolyte solvents; thus, formation of an SEI layer on the nanostructures of the internal nanostructures 12 (on immersion in the electrolyte or if fracture occurs during cycling) is mitigated, while a stable SEI can form on the outside carbon material 11 shell.

The crumpled shell structure in and of itself, thereby, specifically addresses the degradation of electrochemical cell performance due to the two fundamental electrochemical cell degradation mechanisms, specifically anode electrode electrical disconnection and unstable SEI formation as previously discussed. Fourth, the channels within the crumpled ball stack of the electrode allow electrolyte to permeate easily facilitating Li⁺ transport and electron transfer kinetics. Fifth, unlike hollow spheres, the crumpled shell structure can clasp the internal nanostructure cargo within its folds, thus preventing nanostructure aggregation during the charge/discharge cycle of the battery. Hence, the crumpled ball-like particle structure provides both high free volume and high compressive strength, and offers tight negative electrode packing without significantly reducing the area of accessible surface. Such properties are highly desirable for use in electrochemical cells requiring high rate charge/discharge capability. Such crumpled ball-like particles 10 are made through dimensional transition from flat sheets to fractal dimensional crumpled particles using an aerosol flow process that is compatible with electrode slurry coating techniques. An embodiment comprises crumpled graphene or graphene-based sheets that form a crumpled graphene or graphene-based shell encapsulating a silicon-based internal cargo second component.

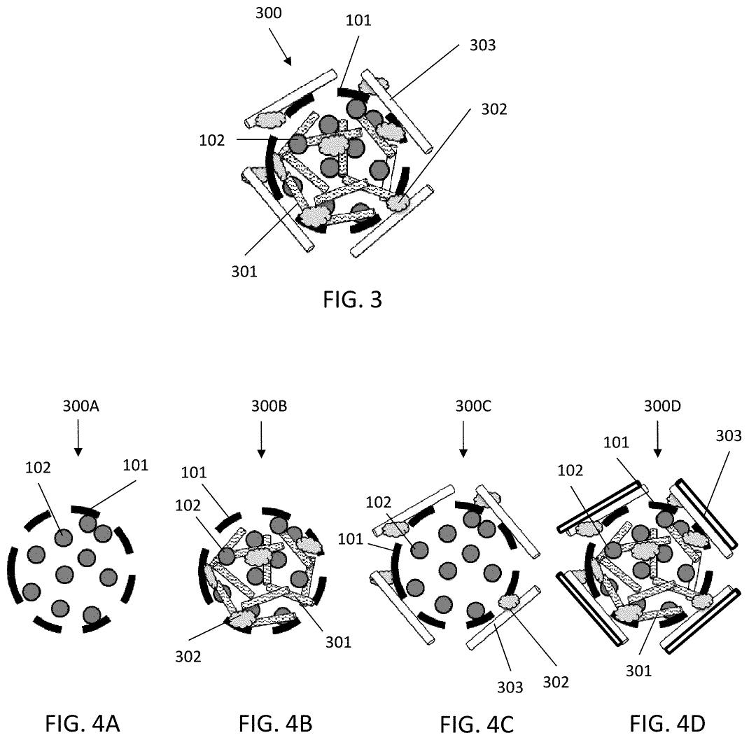

FIG. 2A illustrates the method and apparatus 200 for forming crumpled ball-like composite particles, and FIG. 2B includes micrographs of products formed during stages of the method of FIG. 2A. Referring to FIGS. 2A and 2B, there are four stages within this method and through this apparatus 200. An atomizer 201 nebulizes a dispersion to form aerosol droplets 202 outside of the furnace 203. An embodiment of the dispersion may comprise only carbon-based materials consisting of sheets of graphene, graphene oxide, partially reduced graphene oxide, CNTs, or combinations thereof. Another embodiment of the dispersion may comprise both carbon-based materials consisting of sheets of graphene, graphene oxide, partially reduced graphene oxide, CNTs, or combinations thereof and an electrochemically active material. Yet another embodiment of the dispersion may comprise the carbon-based materials consisting of sheets of graphene, graphene oxide, partially reduced graphene oxide, CNTs, or combinations thereof and one of a crosslinking or non-crosslinking polymer. Another dispersion may comprise both carbon-based materials consisting of sheets of graphene, graphene oxide, partially reduced graphene oxide, CNTs, or combinations thereof and an electrochemically active material, and one of a crosslinking or non-crosslinking polymer.

Nebulizing outside of the furnace 203 may be important, as this allows the particles 100 to become ordered within the droplet before aerosol evaporation initiates. Graphene material particles migrate to the aerosol droplet 202 surface to later form a hollow sphere; the electrochemically active material particles locate themselves central to the droplet (FIG. 2B stage 1). The ordered aerosol droplets 202 are then flown through a preheated furnace 203 where the carbon material particles are localized to cluster and tile at the droplet surface and are ready to encapsulate the electrochemically active material centrally located within the droplet 202. The clustering and tiling while encapsulating occurs as the droplet shrinks due to evaporation during drying (FIG. 2B, stage 2). The carbon material sheets are then concentrated fully surrounding the internal cargo 102 forming an initial ball-like structure (FIG. 2B, stage 3). With continued droplet shrinkage, curvature is introduced followed by pronounced wrinkles, bends and twisted edges. Eventually, the sheets isotropically compress through capillary forces that fully collapse and plastically deform the sheet structures into crumpled balls having a myriad of wrinkles, bends and twists that do not relax the ball-like shape over time (FIG. 2B, stage 4). Plastic deformation of the sheet structures is important to the integrity of the particle, as any relaxation of the carbon material-based shell would re-introduce the internal particle cargo to electrolyte exposure and the effects of fracture and unstable SEI formation.

Preparation of the dispersion solution is important, as the intention is to create a heterogeneous droplet 202 comprising solid particles suspended in the liquid forming the droplet. The liquid forming the droplets 202 should be one that preserves the integrity of the particles 100 within so that particles will isotropically compress and plastically deform to form a near-spherical particle 100 just like a crumpled paper ball. It is also important for the droplets 202 to be sustained in the furnace 203 carrier gas 204 for the duration (that is, until full evaporation is achieved) in order to complete the crumpled ball-like shell structure and the encapsulation of the internal cargo. The apparatus 200 and methods thus provide an aerosol assisted evaporation capillary compression process specifically intended to create particles resembling hollow balls that can encapsulate an internal cargo if desired.

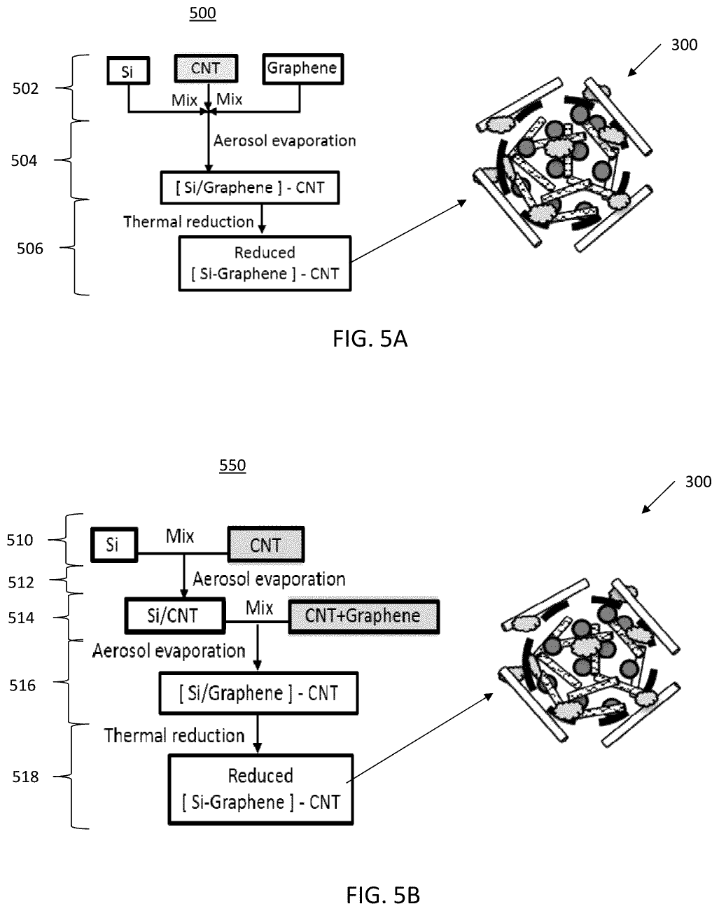

FIG. 3 illustrates an embodiment of a composite particle 300 of an advanced anode material, according to various embodiments of the present disclosure. The particle 300 may include a core comprising an electrochemically active material 102 and a shell or capsule that surrounds the core and comprises sheets of a graphene-based material 101. The graphene-based material 101 may include crumpled sheets of graphene, graphene oxide, and/or partially reduced graphene oxide. The active material 102 may include (i) Silicon (Si), germanium (Ge), tin (Sn), lead (Pb), antimony (Sb), bismuth (Bi), zinc (Zn), aluminum (Al), and cadmium (Cd); alloys thereof, intermetallic compounds thereof, oxides thereof, or any combination thereof.

The particle 300 may include internal CNTs 301 disposed in the core and/or external CNTs 302 disposed in the capsule. The CNTs 301, 303 may be single wall nanotubes (SWCNTs), double wall carbon nanotubes (DWCNTs), multiwall carbon nanotubes (MWCNTs), or any combination thereof. The CNTs 301, 303 may have an average aspect ratio that ranges from about 100 to about 10,000. The CNTs 301, 303 may include short CNTs ranging from about 100 nm to about 3 μm, long CNTs ranging from about 3 μm to about 20 μm, or combinations thereof. In some embodiments, the external CNTs 303 may be long CNTs and the internal CNTs 301 may be short CNTs. However, the CNTs 301, 303 may include short, long, or both short and long CNTs. In some embodiments, the composite particle may comprise from about 65 wt % to about 99 wt % active material, from about 1 wt % to 35 wt % graphene material, and from about 0.1 wt % to about 10 wt % CNTs, based on the total weight of the composite particle. In other embodiments, the composite particle may comprise from about 65 wt % to about 75 wt % active material, from about 20 wt % to 30 wt % graphene material, and from about 1 wt % to about 10 wt % CNTs, based on the total weight of the composite particle. For example, the composite particle 300 may include about 70 wt % active material, about 25 wt % graphene material, and about 5 wt % CNTs.

The composite particle 300 may optionally include a crosslinking polymer 302. The crosslinking polymer 302 may be disposed in the core, the shell, or both the core and the shell. Alternatively, the particle 300 may optionally include a non-crosslinking polymer (not shown) in addition to or in place of the crosslinking polymer 302. In other embodiments, the particle 300 may include no polymers. The performance data from the examples provided within, which will be discussed in more detail later, demonstrate how a CNTs and/or a crosslinking polymers influence electrochemical cell high power performance.

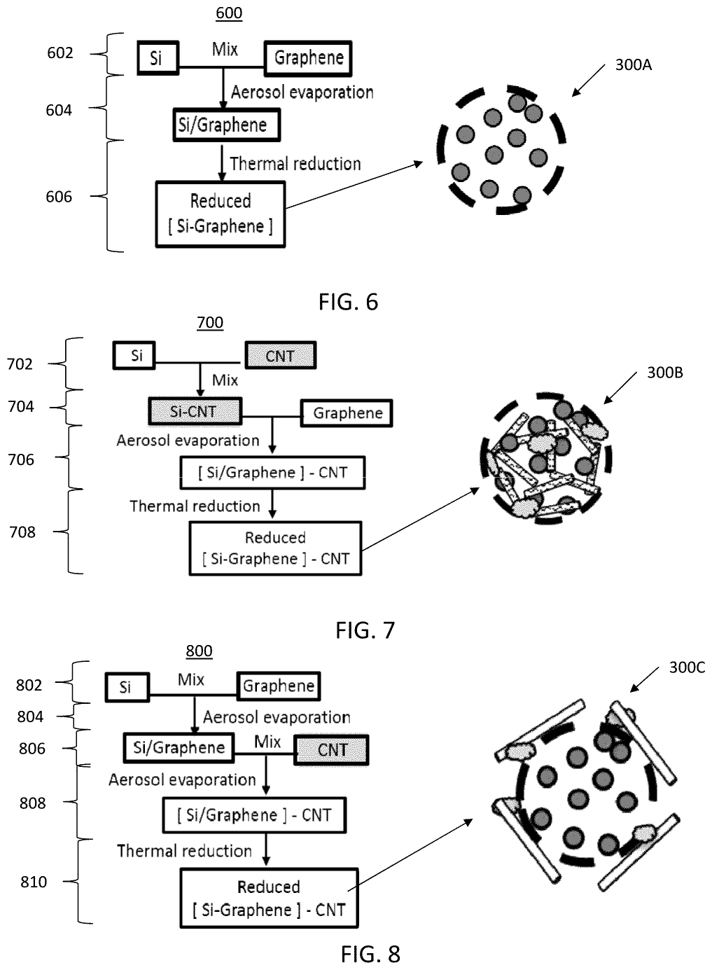

FIGS. 4A through 4D illustrate cross sectional views of modified composite particles 300A-300D, according to various embodiments of the present disclosure. Referring to FIGS. 4A-4D, the composite particles 300A-300D are similar to the composite particle 300 of FIG. 3. Accordingly, only the differences therebetween will be discussed in detail.

Referring to FIG. 4A, the composite particle 300A includes a shell comprising crumpled graphene material sheets 101, and a core comprising active material particles 102. Unlike the composite particle 300 of FIG. 3, the composite particle 300A lacks the CNTs 301, 303 and crosslinking polymer 302.

Referring to FIG. 4B, the composite particle 300B includes a shell comprising sheets of a graphene-based material 101 encapsulating a core comprising internal CNTs 301, electrochemically active material particles 102 and a crosslinking polymer 302. Unlike the composite particle 300, the composite particle 300B does not include external CNTs 303 in the shell.

Referring to FIG. 4C, the composite particle 300C includes external CNTs 303 but does not include internal CNTs 301. In addition, the composite particle 300C includes a crosslinking polymer 302 that is localized in the shell and omitted from the core of the particle 300C.

Referring to FIG. 4D, the composite particle 300D comprises double-walled external CNTs 303 and single-walled internal CNTs 301. Additionally, particle 300D includes a crosslinking polymer 302 that is both in the shell and in the core of the particle 300D,

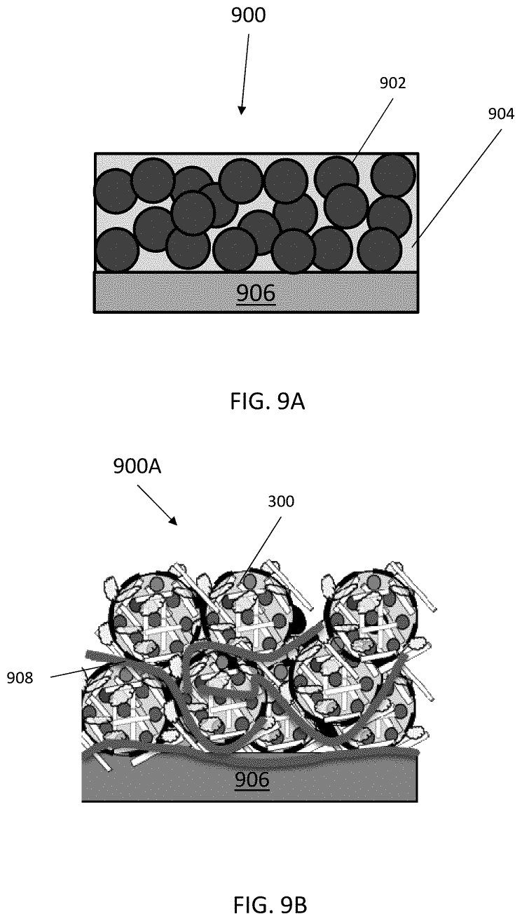

FIGS. 5A and 5B include block diagrams illustrating methods 500 and 550 of forming the composite particle 300 of FIG. 3, according to various embodiments of the present disclosure. Referring to FIG. 5A, in step 502, the method 500 may include mixing an active material (e.g., silicon nanoparticles), CNTs, and graphene in a carrier such as water, to form a mixture. The mixture may have a Si/CNT/graphene content of about 1 wt %, based on the total weight of the mixture. However the Si/CNT/graphene content may range from about 0.5 wt % to about 10 wt %, such as from about 1 wt % to about 5 wt %. A solids content of the mixture may include from about 65 wt % to about 99 wt % active material, from about 1 wt % to 35 wt % graphene material, and from about 0.1 wt % to about 10 wt % CNTs, based on the total solids content. In some embodiments, a solids content of the mixture may include from about 65 wt % to about 75 wt % active material, from about 20 wt % to 30 wt % graphene material, and from about 1 wt % to about 10 wt % CNTs, based on the total solids content. For example, the mixture may include about 70 wt % active material, about 25 wt % graphene material, and about 5 wt % CNTs, based on the total solids content of the mixture.

In step 504, the method may include the aerosol evaporation of the mixture. In particular, step 504 may include aerosolizing the mixture to form droplets, and then conveying the droplets through a tube furnace 200 using a carrier gas, as shown in FIG. 2A. The droplets may be isotropically crumpled and compressed to form a resultant powder, in some embodiments. However, other evaporation methods may be used. In step 506, the method may include reducing a powder produced in step 504 to complete the composite particles 300. For example, the thermal reduction may be performed at about 700° C., in an inert gas atmosphere, such as in argon, nitrogen or combinations thereof.

Referring to FIG. 5B, in step 510, the method 550 may include mixing an active material (e.g., silicon nanoparticles) and CNTs in a carrier such as water, to form a first mixture. The first mixture may include about 1.0 wt % of Si/CNTs, based on the total weight of the first mixture. In step 512, the first mixture may be aerosolized and evaporated, to form silicon/CNT particles. For example, the first mixture may be evaporated using a tube furnace as described above in FIG. 2A. In step 514, the silicon/CNT particles may be collected and mixed with CNTs and a graphene material in a carrier such as water, to form a second mixture. The second mixture may include a Si/CNTs/graphene content of about 1.0 wt %, based on the total weight of the second mixture. However the Si/CNTs/graphene content of the second mixture may range from about 0.5 wt % to about 10 wt %, such as from about 1 wt % to about 5 wt %.

In step 516, the second mixture may be aerosolized and evaporated as described above, and a resultant powder may be collected. In step 518, the powder may be thermally reduced as described above, to form the composite particles 300. The CNTs added to the second mixture may be the same type of CNTs as included in the first mixture. In the alternative, the CNTs added to the second mixture may be different from the CNTs added to the first mixture. For example, if the second mixture includes double walled CNTs, the composite particles 300D of FIG. 4D may be produced.

FIG. 6 includes a block diagram illustrating a method 600 of forming the composite particle 300A of FIG. 4A, according to various embodiments of the present disclosure. Referring to FIG. 6, in step 602, the method 600 may include mixing an active material (e.g., silicon nanoparticles) and graphene in a carrier such as water, to form a mixture.

In step 604, the method 600 may include the aerosol evaporation of the mixture to form a Si/graphene powder, such as by using a tube furnace as described above. In step 606, the powder formed in step 604 may be collected and thermally reduced, as described above, to form the composite particles 300A.

FIG. 7 includes a block diagram illustrating a method 700 of forming the composite particle 300B of FIG. 4B, according to various embodiments of the present disclosure. Referring to FIG. 7, in step 702, the method 700 may include mixing an active material (e.g., silicon nanoparticles) and CNTs to form a Si/CNT powder. In step 704, the Si/CNT powder may be mixed with a graphene compound and in water, to form a mixture. The mixture may include a wt % of the Si/CNT powder as described above, such as about 1 wt %.

In step 706, the method 700 may include the aerosol evaporation of the mixture. The aerosol evaporation of the mixture may include using a tube furnace as described above. In step 708, a powder formed by step 706 may be collected and thermally reduced, as described above, to form the composite particles 300B.

FIG. 8 includes a block diagram illustrating a method 800 of forming the composite particle 300C of FIG. 4C, according to various embodiments of the present disclosure. Referring to FIG. 8, in step 802, the method 800 may include mixing an active material (e.g., silicon nanoparticles) and a graphene compound in a carrier such as water, to form a first mixture. The first mixture may have a solids content as described above. In step 804, the method 800 may include the aerosol evaporation of the first mixture to form a Si/graphene powder.

In step 806, CNTs may be added to the Si/graphene powder, in a carrier such as water, to form a second mixture. The second mixture may include a Si/graphene/CNT wt % as described above, such as about 1 wt %.

In step 808, the method 800 may include the aerosol evaporation of the second mixture. The aerosol evaporation of the mixture may include using a tube furnace as described above. In step 810, a powder formed by step 808 may be collected and thermally reduced, as described above, to form the composite particles 300C.

Any of the above methods may be modified to provide desired properties, for example, but not limited to, electrode flexibility, strength, stiffness, electrical conduction, thermal conduction, porosity, electrolyte absorption, Li⁺ transfer, and the like. For example, different types of CNTs may be included in the methods, such that the core and/or shell of a composite particle may include different corresponding CNTs. In other embodiments, additional elements, such as crosslinking polymers, may be added during the methods. In other embodiments, the relative amounts of the carbon material, CNTs, and/or graphene material may be varied.

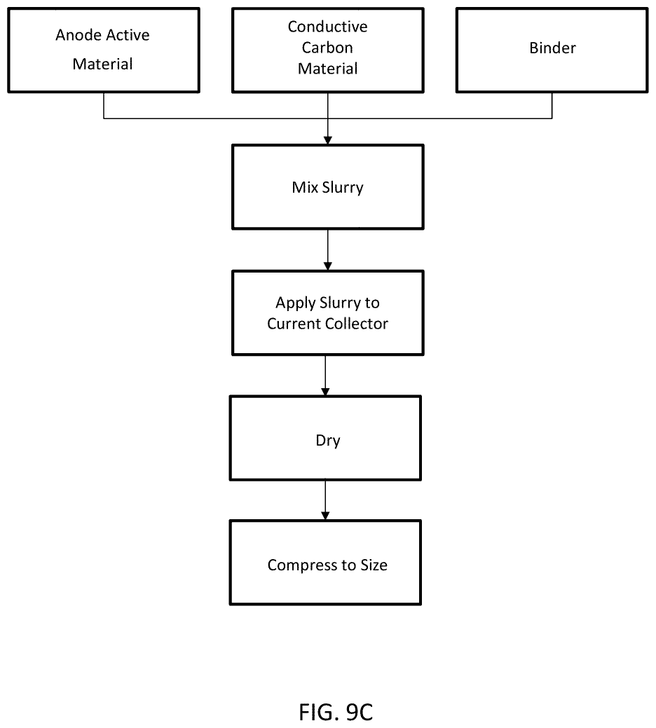

FIG. 9A is a cross-sectional view of an anode 900, according to various embodiments of the present disclosure. FIG. 9B is a cross-sectional view of an anode 900A including the composite particles 300 of FIG. 3. FIG. 9C is a block diagram illustrating a method of forming an anode, according to various embodiments of the present disclosure.

Referring to FIG. 9A, the anode 900 includes composite particles 902 disposed in an electrically conductive matrix 504 on a negative electrode current collector 906. The composite particles 902 may be any of the composite particles 300-300D described above, for example.

The matrix 904 may be a light-weight, mechanically sturdy matrix that is sufficiently flexible to accommodate electrode volume changes during electrochemical cell charge/discharge. For example, the matrix 904 may be configured to accommodate volume changes in the composite particles 902.

The matrix 904 may include graphene material sheets, CNTs, or a combination thereof. For example, as shown in FIG. 5B, the matrix may include graphene material sheets 908 and/or CNTs wrapped around the composite particles 300. The matrix 904 may optionally include crosslinking and/or non-crosslinking polymers.

In some embodiments, the matrix 904 may optionally include binders or other additional current conductive additives, or may be formed as a self-supporting electrode structure without binders or additional current conductor additives. The matrix 904 may be an electrically conductive, carbon-based material network supporting the composite particles 902. For example, the matrix 504 may include graphene-based material sheets and/or carbon nanotubes that are wrapped around or bonded to the composite particles 902, so as to form a continuous 3-dimensional network of the particles 502.

The anodes 900, 900A may be prepared may be prepared starting with graphene or graphene-based sheets 908, derived from low cost graphite and using a simple, easily scalable procedure in which an electrically active material, in the form of nanoparticles and/or thin films, are dispersed in, or deposited on, a graphene composite, and a portion of the graphene sheets 908 may be subsequently reconstituted into graphite to form a continuous, highly conducting network that also serves as a structural scaffold to anchor the graphene sheets 908 that sandwich and trap the active material nanoparticles 902 and/or thin films.

Referring to FIG. 9C, an anode such as anode 900 may be prepared by mixing 0.75 g of the anode active material composition, comprising on average 50 nm particle size and having a 70% silicon by weight encapsulated in the carbon material shell, mixed with 0.05 g of carbon black and 0.2 g of a polymer binder to form a slurry. The slurry may then be applied to a copper foil current collector with a loading of 2.0 Ah/cm² and a density of 1.2 to 1.2 g/cc. The slurry may then be dried and then sized by calendaring or compressing to an internal porosity of 45-50% to form the electrode.

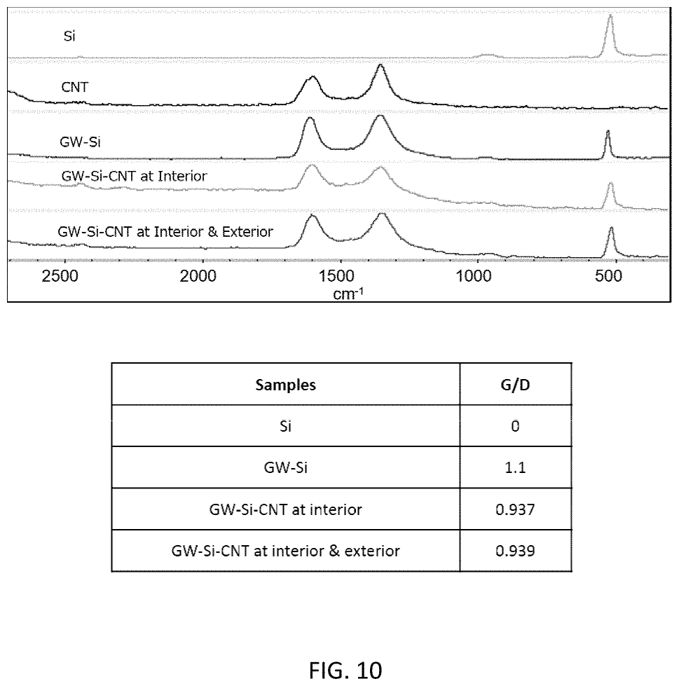

FIG. 10 displays the Raman spectra for various examples of anode materials and compositions of the present application. A table listing G/D ratios is also shown. Raman spectroscopy is a highly sensitive characterization technique to study the structural properties of carbon materials and is well suited for detecting small changes in material morphology. It is very sensitive to short range disorder in carbon material and can also expose the different forms of amorphous carbons. Raman spectroscopic techniques are used to study the vibrational, rotational and other low frequency modes. The shift in wavelength is unique for every material providing a clear fingerprint for a given material.

The intensities of Raman spectra are dependent on the ratios of D (1330 cm₋₁) and G (1596 cm₋₁) band intensities and structural properties of the carbon materials. The D and G band ratio can be used to measure the crystalline size of a carbon material, the ratio off which is inversely proportional to the crystalline size. The Raman spectrum can also be used to measure the order occurring along the c axis. The second order D and G-band is sensitive to the degree of graphitization of a material.

The D and G band ratio is also a good indicator of the quality of bulk material samples. The intensities of these bands indicate the quantity of structural defects (the greater the intensity, the higher the quantity of structural defects). Thus, different types of structural defects can be defined using Raman, such as edges, grain boundaries, vacancies, implanted atoms and defects associated to a change of carbon-hybridization, for example from sp² into sp³ (typically insulating) carbons. The amount and nature of defects strongly depend on the production method and may change from sample to sample. Both the amount and the nature of defects can have a strong influence on the properties of a carbon materials and can strongly vary with the material production and processing methods.

Analysis of the G and D bands is one of the premier ways to characterize the quality of specific carbon materials. The G band is associated with hexagonal C—C bonds of carbon providing information regarding the properties of carbon materials, including thermal conductivity, electrical conductivity, material strength, and the like. The D band is associated with edge structure and point defects in the carbon lattice that may disrupt lattice order and diminish desired material quality.

Referring to FIG. 10, Raman spectra of various examples of anode materials and compositions are shown in the graphs. The spectra of these samples were acquired using 532-nm laser excitation wavelength. Close examination of the spectra and analysis of the G and D bands of the graphene containing samples indicate G/D ratios well over 0.7. G/D ratios at 532-nm within the range of 0.8 to 1.2 are desirable. The data of the present application are provided in the table below the spectra. The data show that the samples made using the methods steps disclosed exhibit G/D ratios within the desired range indicating low defect density, thus good quality anode composite materials. These anode material compositions thus provide higher electrical and thermal conductivities, which translates into electrodes capable of higher charge/discharge rates.

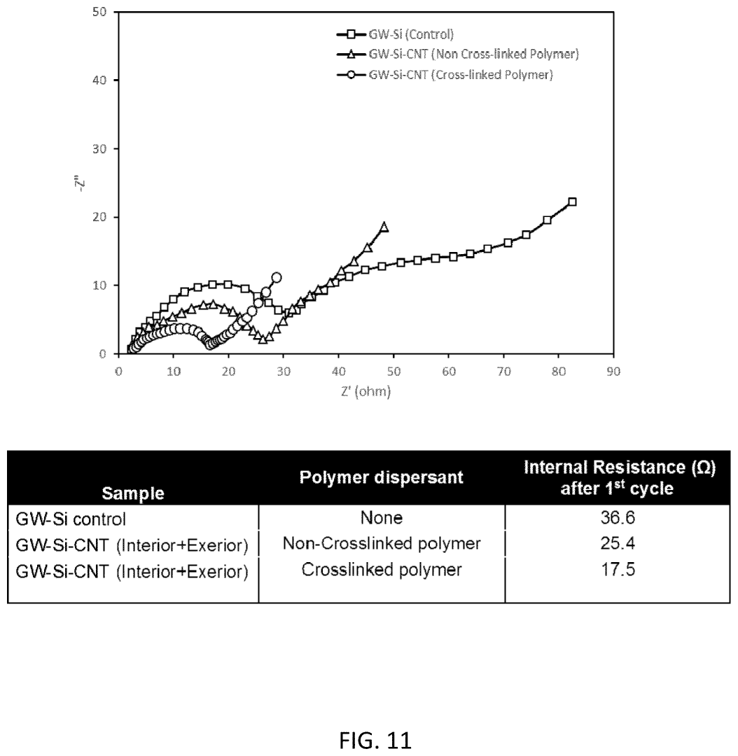

FIG. 11 includes a graph showing Electrochemical Impedance Spectroscopy (EIS) measurements for various examples of electrochemical half cells made using negative electrodes comprising the anode material compositions of the present application. An electrolyte comprising 1.2M LiPF₆ in EC:DMC (30:70 percent by weight) and 20% FEC by weight was used. A summary of the electrode internal resistance measurements after the first charge/discharge cycle is given in the table below the graph. The measurements were taken from cells discharged to 50% to a threshold voltage of in the range between 0.2 and 1.5V.

The electrochemical impedance spectra of half-cells were acquired after the initial cycle at a 50% state of charge in the lithiated state. The EIS was performed using a PARSTAT 2273 electrochemical workstation, with the frequency range and voltage amplitude set as 100 kHz to 0.01 Hz and 5 mV, respectively.

EIS is a non-destructive technique often used to analyze and characterize electrochemical systems and to understand the interfacial behavior in electrochemical systems. The ability of the technique to segregate various processes, i.e., ohmic conduction, charge transfer, interfacial charging, mass transfer and the like, makes it an exceptional technique for understanding the negative electrodes of lithium ion cells. The EIS technique involves a determination of, in this case, the negative electrode impedance, in response to a small amplitude AC signal at any constant DC potential over a span of frequencies. From the measured electrode impedance, it is possible to examine and qualitatively determine several processes, such as the electronic/ionic conduction in the electrode, interfacial charging either at the surface films or the double-layer, charge transfer processes and mass transfer effects.

The semi-circles shown in the graph of FIG. 11, acquired at the test frequency range, is representative of the internal resistance of the negative electrode example as it relates to both the resistance of the solid electrolyte interface (SEI), the SEI being a surface film formed on the electrode when exposed to an electrochemical cell electrolyte, and the resistance of the charge transfer in the electrode. Three test cells were tested.

A first test cell was constructed using a negative electrode material that included composite particles comprising CNTs within the electrochemically active material of the core, CNTs as part of the electrically conductive shell encapsulating the core, and that included a crosslinked polymer.

A second test cell was constructed using a negative electrode material that included composite particles comprising CNTs within the electrochemically active material of the core and CNTs as part of the electrically conductive shell, but included a non-crosslinked polymer rather than a crosslinked polymer.

A third test cell, serving as a control, included a negative electrode material that included composite particles that lacked CNTs, a crosslinked polymer, and a non-crosslinked polymer. The data provided in the table below the graph show substantial decreased internal resistance of the first test cell compared with the second and third cells. Additionally, the data shows that the addition of CNTs to the composite particles substantially decreased internal resistance, regardless of whether a crosslinking polymer 302 was present. The data also indicate that the crosslinked polymer further improved conductivity. These results indicate that CNTs impart conductivity benefits that further improve the charge/discharge capability of a negative electrode These results also indicate that the presence of a crosslinking polymer imparts additional conductivity benefit to further enhance the charge/discharge capability of a negative electrode.

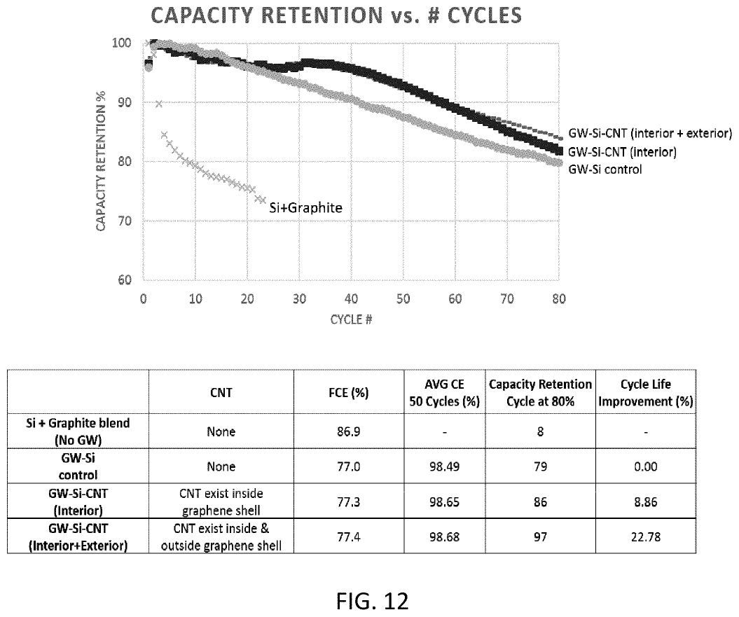

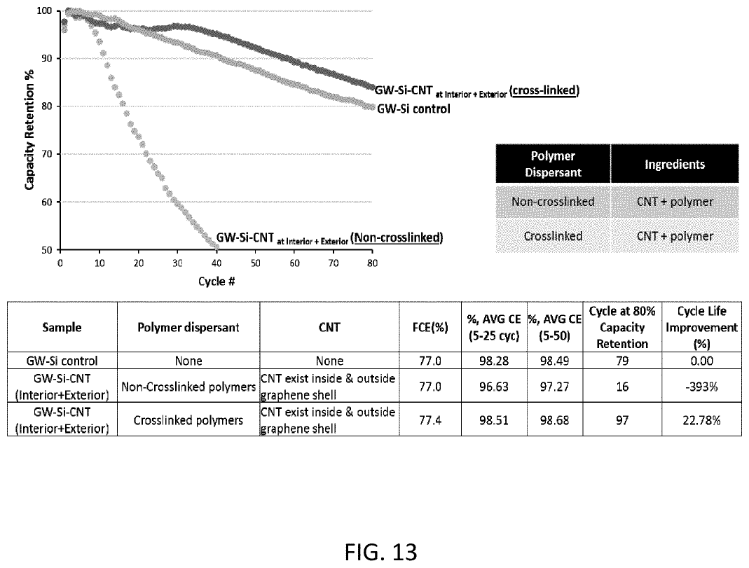

FIGS. 12 and 13 represent example performance data for electrochemical cells of the present application. Three sets of lithium ion coin cells (of the type 2032 with a glass fiber separator and a 9/16 inch electrode size) were constructed, each of which include an anode comprising 0.75 g (70% by weight) of an electrochemically active material comprising 50 nm particle size silicon encapsulated in a carbon material shell 101 comprising graphene mixed with 0.05 g of carbon black and 2.0 g (solid content: 0.2 g) of lithium polyacrylate (Li-PAA) binder. A slurry was made and applied to a copper foil current collector 601 having a loading of 2.0 mAh/cm² and a density of 1.1-1.2 g/cc. The slurry was dried and calendared to an internal porosity of 45-50% to form the electrode 600, 700, 900. The electrode 600, 700, 900 was assembled into a cell having a counter electrode consisting of lithium. An electrolyte comprising 1.2M LiPF₆ in EC:DMC (30:70 percent by weight) and 20% FEC by weight was used. All lithium ion coin cells were subjected to a discharge test regimen to assess their capacity retention and coulombic efficiency. Each of the cells were subjected to a discharge rate sequence comprising C/20 for the first cycle, C/10 for the second cycle, C/5 for the third cycle, and C/2 for all subsequent cycles to a predetermined threshold voltage of about 1.5 V.

While PAA is the binder used in the example cells, it is understood that other binders for the anode electrodes may be used, such as, but not limited to, polyvinylidene fluoride (PVdF), polyvinylpyrrolidone, polytetrafluoroethylene, tetrafluoroethylene-hexafluoropropylene copolymers, vinylidene fluoride-hexafluoropropylene copolymers (P(VDF-HFP)), vinylidene fluoride-chlorotrifluoroethylene copolymers (P(VDF-CTFE)), polyimide, ethylene-propylene-diene ternary copolymers, styrene-butadiene rubbers, carboxymethyl cellulose(CMC), polyaniline, sodium carboxymethyl cellulose, poly(vinyl alcohol) (PVA), polyacrylonitrile (PAN), polyimide (PI), sodium alginate (SA), and polymerized β-cyclodextrin (β-CDp). Additionally, any of the binders herein mentioned may be used alone or in combination for use in anode electrodes of the present application. For example, binder combinations of at least two polymer compounds may be used to enhance overall electrode binder property, such as when PAA and CMC are applied simultaneously in silicon anodes, thereby providing a cross-linked structure to each other that is effectively formed through the condensation reaction between them. Anode electrodes, accordingly, have been shown to exhibit better cycle performance. Another useful binder combination involves synthesizing a multifunctional polymer binder by introducing fluorenone, methylbenzoate ester groups, and triethylene oxide monomethyl ether side chains to polyfluorene type conductive polymers, creating a functional binder for anode electrodes wherein the electrode exhibits high electrical conductivity, mechanical adhesion, ductility and electrolyte permeation.

FIG. 12 includes a graph showing percent capacity retention vs. number of cycles for four examples of electrochemical cells, along with a Table summarizing electrochemical cell performance. In particular, FIG. 12 compares: Example 1) electrochemical cells comprising anode electrodes that included composite particles having CNTs in both the core and the shells of the particles; Example 2) electrochemical cells comprising anode electrodes that included composite particles having core CNTs only; Example 3) control electrochemical cells comprising anode electrodes that included composite particles having no CNTs; and Example 4) comparative electrochemical cells comprising anode electrodes that included a Si and graphite blend rather than composite particles. The test data show that Examples 1 and 2, including CNTs, displayed superior performance to Examples 3 and 4 that did not include CNTs.

Whereas the Example 4 cells exhibited only 8% capacity retention at 80% of discharge, the Example 1-3 cells exhibited capacity retentions an order of magnitude greater, ranging from about 79% to about 97% at 80% of discharge. Example 2 cells having anode electrodes made using CNT-enhanced core particles exhibited about 7% more capacity retention than did the Example 3 cells having anode composite particles that were not CNT-enhanced, and Example 1 cells having anode electrodes made using both CNT-enhanced cores and shells exhibited about 18% more capacity retention than did the Example 3 cells that were not CNT-enhanced. Additionally, the Example 1 cells exhibited about 11% more capacity retention over the Example 2 cells having anode electrodes made using CNT-enhanced core only composite particles.

FIG. 13 includes a graph showing percent capacity retention vs. number of cycles for various examples of electrochemical cells, along with a Table summarizing electrochemical cell performance. In particular, FIG. 13 includes: Example 1 cells including negative electrodes having CNT enhanced composite particles with crosslinked polymers; Example 2 cells that included CNT enhanced composite particles having non-crosslinked polymers; and Example 3 control cells that included composite particles lacking polymers and CNTs.

The test data show the effect of the respective polymers on capacity retention for the electrochemical cell groups. For Example 1 and 2 cells, the test data show that the addition of a crosslinking polymer improved capacity retention, as compared to the Example 3 cells. Additionally, test data show that crosslinked polymers provided better capacity retention than non-crosslinked polymers.

Although, in the examples of the present application, silicon was used as the basis of the composite electrochemically active material examples comprising the internal cargo encapsulated by the electrically conductive carbon material shell, it is noted that silicon is only one example of said electrochemically active material. It is appreciated that the internal cargo comprising the composite electrochemically active material may comprise, consist of or consist essentially of other materials. For example, the electrochemically active material of the present application may be selected from the following groups of materials: (i) Silicon (Si), germanium (Ge), tin (Sn), lead (Pb), antimony (Sb), bismuth (Bi), zinc (Zn), aluminum (Al), and cadmium (Cd); (ii) alloys or intermetallic compounds of Si, Ge, Sn, Pb, Sb, Bi, Zn, Al, or Cd, stoichiometric or non-stoichiometric with other elements; (iii) oxides, carbides, nitrides, sulfides, phosphides, selenides, tellurides, antimonides, or their mixtures (e.g., co-oxides or composite oxides) of Si, Ge, Sn, Pb, Sb, Bi, Zn, Al, Fe, or Cd. For instance, SnO or SnO₂ may be admixed with oxides of B, Al, P, Si, Ge, Ti, Mn, Fe, or Zn and then subjected to heat treatments to obtain composite oxides. Composite oxides may also be prepared by mechanical alloying (e.g., ball milling of a mixture of SnO and B₂O₃). SnO or SnO₂ alone is of particular interest due to their high theoretical capacities. Some additional specific examples include metal oxides, such as TiO, ZnO, SnO, CoO, FeO, MnO, MnO, MnO, FeO, NiO, MoC, CuO, CuO, CeO2, RuO and NO. Examples of expandable, electrochemically active materials, include Sn, Ge, Sb, or other monometallic, bimetallic, or multimetallic materials, oxidic or sulfide materials, or their mixtures.

Additionally, while graphene was used in the carbon material examples of the present application, it is appreciated that the graphene may be obtained from exfoliation and separation of graphene sheets of a laminar graphite material selected from natural graphite, synthetic graphite, highly oriented pyrolytic graphite, graphite fiber, carbon fiber, carbon nano-fiber, graphitic nano-fiber, spherical graphite or graphite globule, meso-phase micro-bead, meso-phase pitch, graphitic coke, graphitized polymeric carbon, or a combination thereof. Further, the electrically conductive carbon materials may be selected from carbon or graphitic nano-fiber, carbon nano-tube, carbon black, activated carbon powder, or a combination thereof. Additionally, the electrically conductive carbon materials may be selected from an amorphous carbon, polymeric carbon, carbon black, coal tar pitch, petroleum pitch, or meso-phase pitch in physical contact with said particles or coating at least one of the constituents of said particles. Moreover, the electrically conductive carbon materials may be obtained from polymeric carbons realized from pyrolyzation of a polymer selected from the group consisting of phenol-formaldehyde, polyacrylonitrile, styrene-based polymers, cellulosic polymers, epoxy resins, and combinations thereof. Any amorphous carbon material may be obtained from chemical vapor deposition, chemical vapor infiltration, or pyrolyzation of an organic precursor. In addition to graphene, graphene oxide, at least partially reduced graphene oxide, or combination thereof may comprise the composite carbon shell encapsulating the internal cargo.

The CNTs of the present application may comprise single wall, double wall or multiwall nanotubes (SWCNT, DWSNT, MWCNT respectively), including other CNT commercially available, the aspect ratio of which may be selected for best fit to the application charge/discharge rate demands. In some cases the aspect ratios may be as high as 10,000 or as low as about 100 to 1000. CNT lengths may be short (100 nm-3 μm) or long (3 μm-20 μm), once again depending on the application charge/discharge rate demands. Additionally, the CNTs of the present application may be functionalized CNTs including traditional acid chemistry based functionalized CNTs in OH or COOH, plasma functionalized CNTs in oxygen (all the oxygen groups) COOH, NH2, N2, & F groups, or specifically tailored for the amount of groups and specific kind of groups as required. The CNTs may also be at least partially graphitized.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. Composite particles for a negative electrode of an electrochemical cell, the composite particles each comprising:
a capsule comprising crumpled sheets of a graphene material;
a core encapsulated in the capsule, the core comprising an electrochemically active material; and
carbon nanotubes (CNTs) disposed in capsule, the core, or both the capsule and the core.

2. The composite particles of claim 1, wherein the core comprises carbon nanotubes.

3. The composite particle of claim 2, wherein the capsule, the core, or both the capsule and the core comprises a crosslinked polymer.

4. The composite particles of claim 1, wherein the graphene material comprises graphene, graphene oxide, partially reduced graphene oxide, or any combination thereof.

5. The composite particles of claim 1, wherein the composite particles have an average particle size of less than 10 μm.

6. The composite particles of claim 1, wherein the composite particles have an average particle size of from about 4 μm to about 7 μm.

7. The composite particles of claim 1, wherein the electrochemically active material comprises silicon (Si), germanium (Ge), tin (Sn), lead (Pb), antimony (Sb), bismuth (Bi), zinc (Zn), aluminum (Al), cadmium (Cd), an alloy thereof, an intermetallic compound thereof, an oxide thereof, or any combination thereof.

8. The composite particles of claim 1, wherein the CNTs comprise one of single wall nanotubes (SWCNTs), double wall carbon nanotubes (DWCNTs), multiwall carbon nanotubes (MWCNTs), or combinations thereof.

9. The composite particle of claim 3, wherein the average aspect ratio of the CNTs ranges from about 100 to about 10,000.

10. The composite particles of claim 3, wherein the CNTs comprise:
short CNTs having a length ranging from about 100 nm to about 3 μm;
long CNTs having a length ranging from about 3 μm to about 20 μm; or
a combination of the long and short CNTs.

11. The composite particles of claim 1, wherein each composite particle comprises, based on the total weight of the composite particle:
from about 65 wt % to about 99 wt % of the active material;
from about 20 wt % to 35 wt % of the graphene material; and
from about 0.1 wt % to about 10 wt % of the CNTs.

12. An anode comprising:
a current collector;
a matrix disposed on the current collector and comprising a graphene material, graphite, carbon black, a carbon nanotubes, or any combinations thereof; and
composite particles of claim 1 disposed in the matrix.

13. The anode of claim 12, wherein:
the matrix comprises sheets of the graphene material wrapped around or bonded to the composite particles; and
the graphene material comprises graphene, graphene oxide, partially reduced graphene oxide, or any combination thereof.

14. The anode of claim 13, further comprising a crosslinked polymer.

15. The anode of claim 14, wherein the crosslinked polymer comprises:
a first polymer comprising first functional groups; and
a second polymer comprising second functional groups,
wherein at least some of the first and second functional groups are bonded to crosslink the first and second polymers and form the crosslinked polymer.

16. The anode of claim 14, wherein:
the crosslinked polymer comprises polymers that each comprise first and second functional groups, and
at least some of the first and second functional groups are bonded to cros slink the polymers form the crosslinked polymer.

17. A method of making composite particles for a negative electrode of an electrochemical cell, the method comprising:
mixing an active material, carbon nanotubes, and a graphene material to form a mixture;
nebulizing the mixture to form droplets;
evaporating the droplets to form a powder; and
thermally reducing the particles to form the composite particles.

18. The method of claim 17, wherein the mixture further comprises a crosslinking polymer.

19. The method of claim 17, wherein the mixture comprises, based on a total solids content of the mixture:
from about 65 wt % to about 99 wt % of the active material;
from about 20 wt % to 35 wt % of the graphene material; and
from about 0.1 wt % to about 10 wt % of the CNTs.
